(19) United States
(12) Patent Application Publication
(10) Pub. No.: US 2017/0284494 A1
(43) Pub. Date: Oct. 5, 2017

(54) Non Newtonian Fluids As Ultra High Acceleration G-Force Dissipaters And Shock Absorbers

(71) Applicants: Avery Jackson Kress, Marietta, GA (US); Jennice Lynn Ozment, Marietta, GA (US)

(72) Inventors: Avery Jackson Kress, Marietta, GA (US); Jennice Lynn Ozment, Marietta, GA (US)

(21) Appl. No.: 15/089,540

(22) Filed: Apr. 2, 2016

(51) Int. Cl. F16F 9/10; B64G 1/52; F16F 15/023

(52) U.S. Cl. CPC F16F 9/10; F16F 15/023; B64G 1/52; F16F 2238/04; F16F 2222/12

(57) ABSTRACT

The invention relates to the novel usage of shear-thickening and rheopectic non-Newtonian fluids as shock absorbers intended absorbing acceleration or impact via submergence of an object to be protected entirely into non-Newtonian fluid. Additionally, this invention relates to the novel usage of shear-thickening and rheopectic non-Newtonian fluids as shock absorbers capable of absorbing the force of impact or acceleration and effectively dissipating the force away from the object to be protected over an extended duration (greater than an instantaneous impact) more effectively than traditional shock absorbers.

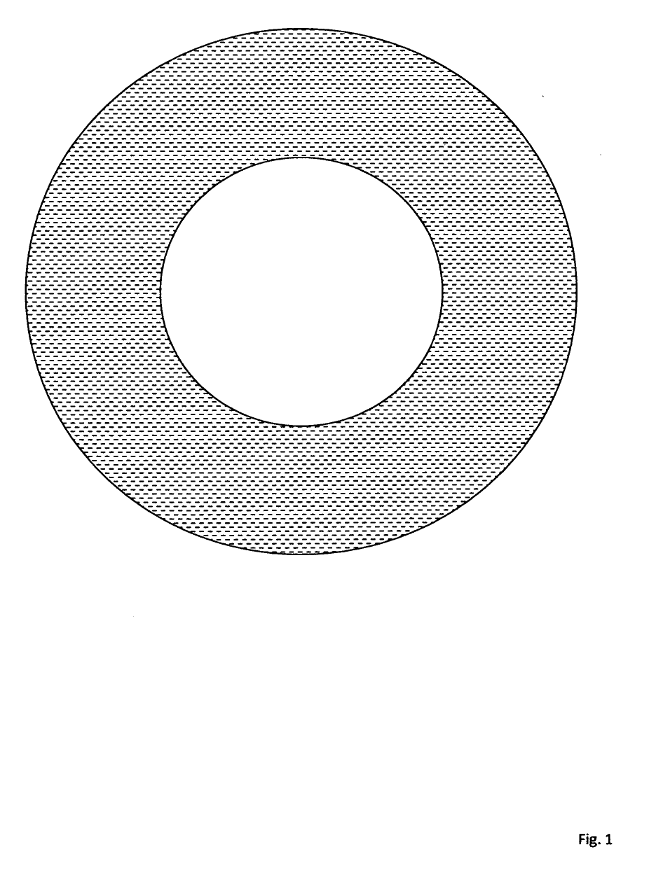

### BACKGROUND OF INVENTION

Non Newtonian fluids are chemicals that exhibit a change in properties, typically either viscosity or density, on stimulation by a shear force, IE: deformation or impact. The primary difference between the behavior of Newtonian and non-Newtonian fluids is that in Newtonian fluids the sheer rate (or strain) can be plotted approximately linearly on a curve in order to plot a change in density over time. Non-Newtonian fluids do not exhibit this linear behavior and thus will thin or thicken at unusual rates under pressure, impact, etc. The primary advantage of Non-Newtonian fluid over other shock absorbers is its' simultaneous fluidity (allowing for easy handling) and ability to convert from liquid to solid and back again almost instantaneously.

Non-Newtonian fluids have in the past seen usage in bullet proof vests, speed bumps, and other applications that benefit from the flexible nature of non Newtonian fluids. In this role they function adequately as “liquid shields” capable of deforming and hardening as needed. However, these fluids are limited in that role as chemical variants on extant, solid materials and armors, and serve neither novel nor extreme roles. In all previous cases, non-Newtonian fluids have only been used as absorbers of blunt impact from an immediate and singular shock.

### SUMMARY OF INVENTION

This invention however explores two entirely novel uses of the unprecedented characteristic of non-Newtonian fluids observed throughout testing. Whereas non-Newtonian fluids have only previously been used to protect against immediate trauma, they may also be used to protect an object from a sustained force such as acceleration. Additionally, non-Newtonian fluids display the ability to distribute impact force evenly throughout any immediately touching fluid and at least in part transfer impact force away from an enshrouded object.

Therefore it is proposed in this claim that non-Newtonian fluids may be used to protect a completely submerged object from either a constant force (namely acceleration) or a blunt impact such as a collision. This usage is advantageous over previous uses as, unlike previous proposals that involve non-Newtonian fluids simply as a layer of immediate protection from a single force, this usage functions more as an all enveloping shield capable of dampening any force or forces an object is subjected to.

Previously, in order to protect objects from damage attained due to shock during transport, the best available shock absorbing materials were only capable of absorbing on the order of ˜50-400 g's. Proposals of non-Newtonian shock absorbers were also limited to near solid like materials that mimic a sort of ceramic. This proposed usage of submerging objects entirely in non-Newtonian fluids has been shown in our tests to be capable of protecting objects while still in fluid form from, in excess of, 6000 g's of acceleration, significantly higher than previous materials or uses.

Practical applications as proposed in this claim include, for one, use in improving the practicality of mass drivers as a means of space launch. Simply put, mass drivers are magnetic cannons capable of accelerating objects to orbital velocity on the ground. They would be far cheaper to use than conventional rocketry, however, they are limited by the shear centripetal force such a launch would impart on an object (in excess of 5000 g's sustained over approximately one minute). The novel use of non-Newtonian fluids as we propose in this claim could be used to protect an object from this force.

A second proposed usage of this invention would be to protect larger objects from forces incurred on impact. We propose that by submerging an object in non-Newtonian fluid the object may be protected from a fall from great height, amongst other impacts. This could be used to land delicate objects on foreign planets or in dangerous environments where current shock absorption methods (inflatable shock absorbing balloons) will not function or cannot absorb enough impact force.

### BRIEF DESCRIPTION OF DRAWING

1. FIGURE one shows a rough sketch of the proposed invention. A line representing the shell of a container holding the non-Newtonian fluid and satellite forms the circumference of the drawing. The horizontal lines represent space in the container occupied by non-Newtonian fluid directly touching the satellite in the core.

### DETAILED DESCRIPTION OF INVENTION

The proposed usage and production of this invention is as follows: shear thickening or rheopectic non-Newtonian Fluid would be gathered in a quantity significant enough to completely submerge the object that is desired to be protected. Ideally, there would be significantly more non-Newtonian fluid in terms of volume that the object's volume. The fluid (with protected object submerged and in physical contact with the fluid) would be enclosed inside a water tight fairing or capsule. This capsule should ideally be spherical as such a shape more evenly distributes the fluid, increasing its' effectiveness. The fairing, when opened would allow the non-Newtonian fluid to flow off of the protected object allowing the object to be removed with ease.

With use in mass drivers or as blunt force shock absorbers, the fairing method state above would remain valid.

Most non shear thickening and rheopectic non-Newtonian fluids would be valid for use in this regard and none is claimed specifically in this patent, only the method of use. For trials however, cornstarch and water mixed to a 4.25-5 par ratio has yielded adequate results.

1. Usage of Non-Newtonian fluids as ultra high acceleration (defined as any acceleration in excess of 50 g's) shock absorbers and g force dissipaters via submerging objects in non-Newtonian fluids.

2. The novel use of non-Newtonian fluids as shock absorbers for high velocity impacts via submerging objects entirely in non-Newtonian fluid (as opposed to only a non-contiguous layer of fluid intended for protecting against a single blunt impact).

3. Use of a mass driver in tandem with this invention to accelerate objects to high velocities under high (>50 g) acceleration.
